(19) United States
(12) Patent Application Publication
(10) Pub. No.: US 2014/0145569 A1
(43) Pub. Date: May 29, 2014

(54) Backplane Structure and Display Device Thereof

(71) Applicant: GuoFu Tang, Shenzhen City (CN)

(72) Inventor: GuoFu Tang, Shenzhen City (CN)

(73) Assignee: Shenzhen China Star Optoelectronics Technology Co. Ltd., Shenzhen (CN)

(21) Appl. No.: 13/704,965

(22) PCT Filed: Dec. 5, 2012
(86) PCT No.: PCT/CN12/85928

§ 371 Date: Dec. 17, 2012

(30) Foreign Application Priority Data
Nov. 23, 2012 (CN) 201220625475.6

(51) Int. Cl. G02F 1/1333

(52) U.S. Cl. CPC G02F 1/133308
USPC 312/223.1

(57) ABSTRACT

The present invention provides a backplane structure and display device thereof. The backplane structure includes a backplane main body; at least a support beam; the support beam being fixed to the backplane main body; wherein the support beam including at least a horizontal wall and at least a vertical wall, the horizontal wall and the adjacent vertical wall being connected perpendicularly, at least a horizontal wall disposed parallely to the backplane main body with interval being disposed with a hanging hole. As such, the backplane structure and display device thereof of the present invention can effectively enhance the overall bend-resistance of the entire backplane structure and reduce the manufacturing cost.

### BACKGROUND OF THE INVENTION

1. Field of the Invention

The present invention relates to the field of liquid crystal displaying techniques, and in particular to a backplane structure and display device thereof.

2. The Related Arts

In know technique of display device, the backplane is used to provide the overall strength and the rigidity required by the display device so that the display device is not prone to bending and deformation. For the display device of super large size, such as, 60 inches and more, the backplane must provide more support. However, the known backplane cannot guarantee the planar rigidity required by the display device of super large size, and improvement is required.

Thus, it is desired to provide a backplane structure and display device that overcomes the above problems.

### SUMMARY OF THE INVENTION

The technical issue to be addressed by the present invention is to provide a backplane structure and display device thereof, which can effectively enhance the overall bend-resistance of the backplane structure and reduce the manufacturing cost.

The present invention provides a backplane structure, which comprises: a backplane main body; at least a support beam; wherein the support beam comprising at least a horizontal wall and at least a vertical wall, the horizontal wall and the adjacent vertical wall being connected perpendicularly, at least a horizontal wall disposed parallely to the backplane main body with interval being disposed with a hanging hole; the support beam being fixed to the backplane main body along the direction parallel to the length of the backplane main body; wherein the support beam comprising a first horizontal wall, a second horizontal wall, a third horizontal wall, a first vertical wall and a second vertical wall; wherein the first horizontal wall being disposed with hanging hole; the first vertical wall and the second vertical wall extending respectively from the two ends of the first horizontal wall towards the backplane main body; the second horizontal wall extending from the end of the first vertical wall away from the first horizontal wall along a first direction parallel to the first horizontal wall; the third horizontal wall extending from the end of the second vertical wall away from the first horizontal wall along a second direction parallel to the first horizontal wall; the second direction being opposite to the first direction; wherein the first vertical wall and the second vertical wall having a same height, the second horizontal wall and the third horizontal wall being fixed to the backplane main body; the first horizontal wall being further away from the backplane main body than the second horizontal wall and the third horizontal wall.

According to a preferred embodiment of the present invention, the support beam has a thickness of 1-4 mm.

The present invention provides a backplane structure, which comprises: a backplane main body; at least a support beam: the support beam being fixed to the backplane main body; the support beam comprising at least a horizontal wall and at least a vertical wall, the horizontal wall and the adjacent vertical wall being connected perpendicularly, at least a horizontal wall disposed parallely to the backplane main body with interval being disposed with a hanging hole.

According to a preferred embodiment of the present invention, the support beam is fixed to the backplane main body along the direction parallel to the length of the backplane main body.

According to a preferred embodiment of the present invention, the support beam is fixed to the backplane main body along the direction parallel to the width of the backplane main body.

According to a preferred embodiment of the present invention, the support beam comprises a first horizontal wall, a second horizontal wall, a third horizontal wall, a first vertical wall and a second vertical wall; wherein the first horizontal wall being disposed with hanging hole; the first vertical wall and the second vertical wall extending respectively from the two ends of the first horizontal wall towards the backplane main body; the second horizontal wall extending from the end of the first vertical wall away from the first horizontal wall along a first direction parallel to the first horizontal wall; the third horizontal wall extending from the end of the second vertical wall away from the first horizontal wall along a second direction parallel to the first horizontal wall; the second direction being opposite to the first direction; wherein the first vertical wall and the second vertical wall having a same height, the second horizontal wall and the third horizontal wall being fixed to the backplane main body; the first horizontal wall being further away from the backplane main body than the second horizontal wall and the third horizontal wall.

According to a preferred embodiment of the present invention, the first vertical wall and the second vertical wall are disposed respectively with lifting hole.

According to a preferred embodiment of the present invention, the second horizontal wall and the third horizontal wall are disposed respectively with installation hole.

According to a preferred embodiment of the present invention, the support beam comprises a first horizontal wall, a second horizontal wall, a third horizontal wall, a first vertical wall, a second vertical wall, a third vertical wall and a fourth vertical wall; wherein the first vertical wall and the second vertical wall extending respectively from the two ends of the first horizontal wall towards away from the backplane main body; the second horizontal wall extending from the end of the first vertical wall away from the first horizontal wall along a first direction parallel to the first horizontal wall; the third horizontal wall extending from the end of the second vertical wall away from the first horizontal wall along a second direction parallel to the first horizontal wall; the second direction being opposite to the first direction; the third vertical wall extending from the end of the second horizontal wall away from the first vertical wall along a direction parallel to the first vertical wall towards the first horizontal wall; the fourth vertical wall extending from the end of the third horizontal wall away from the second vertical wall along a direction parallel to the second vertical wall towards the first horizontal wall; wherein the first vertical wall and the second vertical wall having a same height; the first horizontal wall being fixed to the backplane main body; the second horizontal wall and the third horizontal wall being further away from the backplane main body than the first horizontal wall; the second horizontal wall and the third horizontal wall being disposed respectively with hanging hole.

According to a preferred embodiment of the present invention, the first horizontal wall is disposed with installation hole.

According to a preferred embodiment of the present invention, the first vertical wall and the second vertical wall are disposed respectively with lifting hole.

The present invention provides a display device, which comprises a backplane structure, the backplane structure comprising: a backplane main body; at least a support beam; the support beam being fixed to the backplane main body; the support beam comprising at least a horizontal wall and at least a vertical wall, the horizontal wall and the adjacent vertical wall being connected perpendicularly, at least a horizontal wall disposed parallely to the backplane main body with interval being disposed with a hanging hole.

According to a preferred embodiment of the present invention, the support beam is fixed to the backplane main body along the direction parallel to the length of the backplane main body.

According to a preferred embodiment of the present invention, the support beam is fixed to the backplane main body along the direction parallel to the width of the backplane main body.

According to a preferred embodiment of the present invention, the support beam comprises a first horizontal wall, a second horizontal wall, a third horizontal wall, a first vertical wall and a second vertical wall; wherein the first horizontal wall being disposed with hanging hole; the first vertical wall and the second vertical wall extending respectively from the two ends of the first horizontal wall towards the backplane main body; the second horizontal wall extending from the end of the first vertical wall away from the first horizontal wall along a first direction parallel to the first horizontal wall; the third horizontal wall extending from the end of the second vertical wall away from the first horizontal wall along a second direction parallel to the first horizontal wall; the second direction being opposite to the first direction; wherein the first vertical wall and the second vertical wall having a same height, the second horizontal wall and the third horizontal wall being fixed to the backplane main body; the first horizontal wall being further away from the backplane main body than the second horizontal wall and the third horizontal wall.

According to a preferred embodiment of the present invention, the first vertical wall and the second vertical wall are disposed respectively with lifting hole.

According to a preferred embodiment of the present invention, the second horizontal wall and the third horizontal wall are disposed respectively with installation hole.

According to a preferred embodiment of the present invention, the support beam comprises a first horizontal wall, a second horizontal wall, a third horizontal wall, a first vertical wall, a second vertical wall, a third vertical wall and a fourth vertical wall; wherein the first vertical wall and the second vertical wall extending respectively from the two ends of the first horizontal wall towards away from the backplane main body; the second horizontal wall extending from the end of the first vertical wall away from the first horizontal wall along a first direction parallel to the first horizontal wall; the third horizontal wall extending from the end of the second vertical wall away from the first horizontal wall along a second direction parallel to the first horizontal wall; the second direction being opposite to the first direction; the third vertical wall extending from the end of the second horizontal wall away from the first vertical wall along a direction parallel to the first vertical wall towards the first horizontal wall; the fourth vertical wall extending from the end of the third horizontal wall away from the second vertical wall along a direction parallel to the second vertical wall towards the first horizontal wall; wherein the first vertical wall and the second vertical wall having a same height; the first horizontal wall being fixed to the backplane main body; the second horizontal wall and the third horizontal wall being further away from the backplane main body than the first horizontal wall; the second horizontal wall and the third horizontal wall being disposed respectively with hanging hole.

According to a preferred embodiment of the present invention, the first horizontal wall is disposed with installation hole.

According to a preferred embodiment of the present invention, the first vertical wall and the second vertical wall are disposed respectively with lifting hole.

The efficacy of the present invention is that to be distinguished from the state of the art. The backplane structure and the display device thereof of the present invention can apply the force to the support beam to enhance the overall strength and rigidity of the entire backplane through disposing support beam on the backplane main body and the support beam, disposing perpendicularly connected horizontal wall and vertical wall on the support beam and disposing hanging hole on the horizontal wall that is disposed parallely to the backplane main body with interval. In addition, the horizontal wall and the vertical wall of the support beam can be formed through bending by knife bending machine to save the cost of expensive mold and reduce the manufacturing cost.

### BRIEF DESCRIPTION OF THE DRAWINGS

To make the technical solution of the embodiments according to the present invention, a brief description of the drawings that are necessary for the illustration of the embodiments will be given as follows. Apparently, the drawings described below show only example embodiments of the present invention and for those having ordinary skills in the art, other drawings may be easily obtained from these drawings without paying any creative effort. In the drawings:

FIG. 1 is a schematic view showing the structure of the first embodiment of the backplane structure according to the present invention;

FIG. 2 is a cross-sectional view of A-A line shown in FIG. 1;

FIG. 3 is a schematic view of the support beam shown in FIG. 2;

FIG. 4 is a cross-sectional view of the support beam shown in FIG. 2;

FIG. 5 is a schematic view showing the structure of the second embodiment of the backplane structure according to the present invention;

FIG. 6 is a schematic view of the support beam shown in FIG. 5;

FIG. 7 is a cross-sectional view of the support beam shown in FIG. 5;

FIG. 8 is a schematic view showing the structure of the third embodiment of the backplane structure according to the present invention: and

FIG. 9 is a schematic modular view showing the display device according to the present invention.

### DETAILED DESCRIPTION OF THE PREFERRED EMBODIMENTS

The following refers to drawing and embodiments to describe the present invention in details.

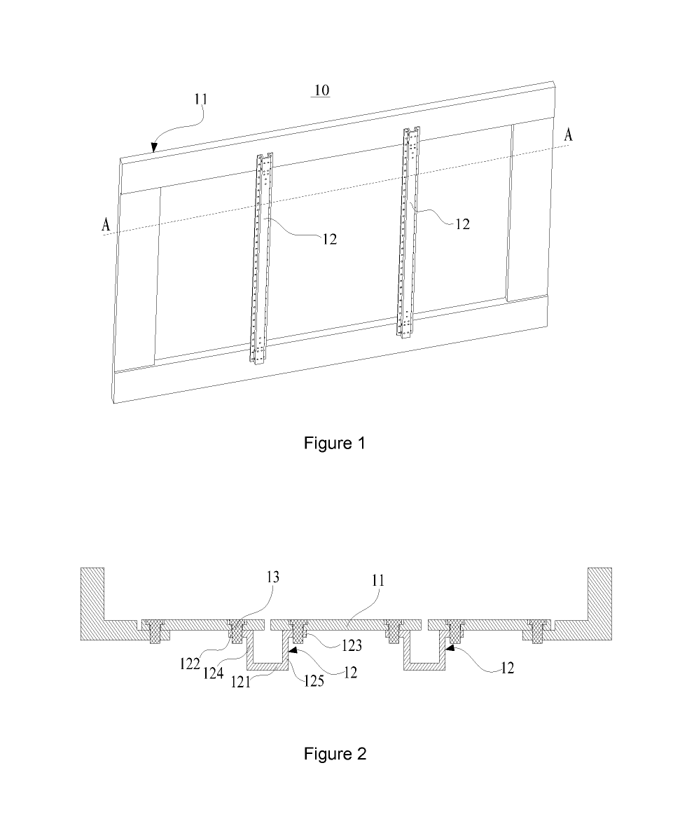

Referring to FIG. 1, FIG. 1 is a schematic view showing the structure of the first embodiment of the backplane structure according to the present invention. A backplane structure 10 comprises a backplane main body 11 and support beams 12. The support beam 12 is fixed to the backplane main body 11, wherein the support beam 12 is fixed to the backplane main body 11 along the direction parallel to the width of the backplane main body 11.

In the instant embodiment, the number of support beams is at least one, but can also be two or more. The specific number of the support beam depends on application and is preferably two in the instant embodiment.

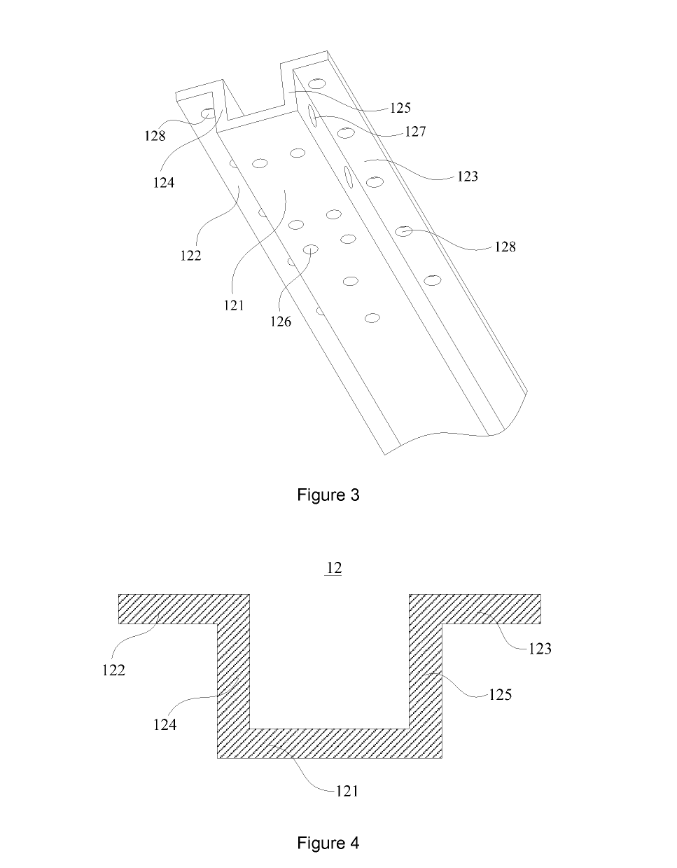

In addition, referring to FIGS. 2-4, FIG. 2 is a cross-sectional view of A-A line shown in FIG. 1; FIG. 3 is a schematic view of the support beam shown in FIG. 2; and FIG. 4 is a cross-sectional view of the support beam shown in FIG. 2. The support beam 12 at least a horizontal wall and at least a vertical wall, and the horizontal wall and the adjacent vertical wall are connected perpendicularly. The horizontal wall and the vertical wall of the support beam 12 can be formed through bending by knife bending machine or other means. The support beam 12 is the element of the entire backplane structure bearing the force. The thickness of the support beam 12 is 1-4 mm, and is preferably 2 mm in the instant embodiment.

Specifically, the support beam 12 comprises a first horizontal wall 121, a second horizontal wall 122, a third horizontal wall 123, a first vertical wall 124 and a second vertical wall 125. The first horizontal wall is disposed parallely to the backplane main body 11. The second horizontal wall 122 and the third horizontal wall 123 are fixed to the backplane main body 11. In other words, the first horizontal wall 121 is further away from the backplane main body 11 than the second horizontal wall 122 and the third horizontal wall 123.

The first vertical wall 124 and the second vertical wall 125 extend respectively from the two ends of the first horizontal wall 121 towards the backplane main body 11. The second horizontal wall 122 extends from the end of the first vertical wall 124 away from the first horizontal wall 121 along a first direction parallel to the first horizontal wall 121. The third horizontal wall 123 extends from the end of the second vertical wall 125 away from the first horizontal wall 121 along a second direction parallel to the first horizontal wall 121. The second direction is opposite to the first direction; wherein the first vertical wall 124 and the second vertical wall 125 have a same height.

In the instant embodiment, the first horizontal wall 121 disposed parallely to the backplane main body 11 with interval is disposed with a hanging hole 126. The hanging hole 126 of the first horizontal wall 121 can also include a rivet to apply the force to the support beam 12 so that the support beam 12 can support the entire backplane structure 10. The first vertical wall 124 and the second vertical wall 125 are disposed respectively with lifting hole 127. A steel string can pass the lifting hole 127 to hoist up the entire backplane structure 10. The second horizontal wall 122 and the third horizontal wall 123 are disposed respectively with installation hole 128. A screw 13 passes the installation hole 128 to fasten the support beam 12 to the backplane main body 11. It is obvious that, in other embodiments, the support beam 12 can be soldered to the backplane main body 11 for fastening.

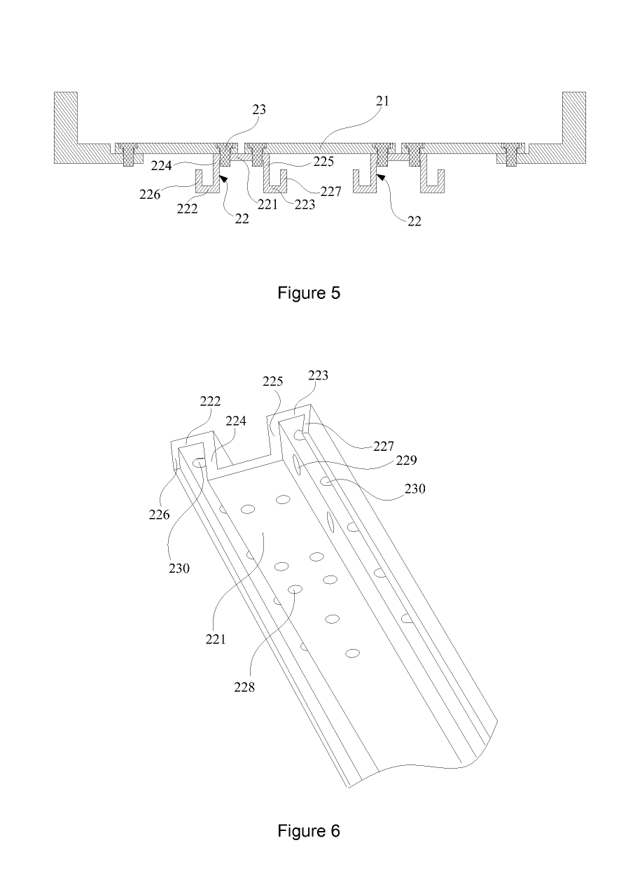

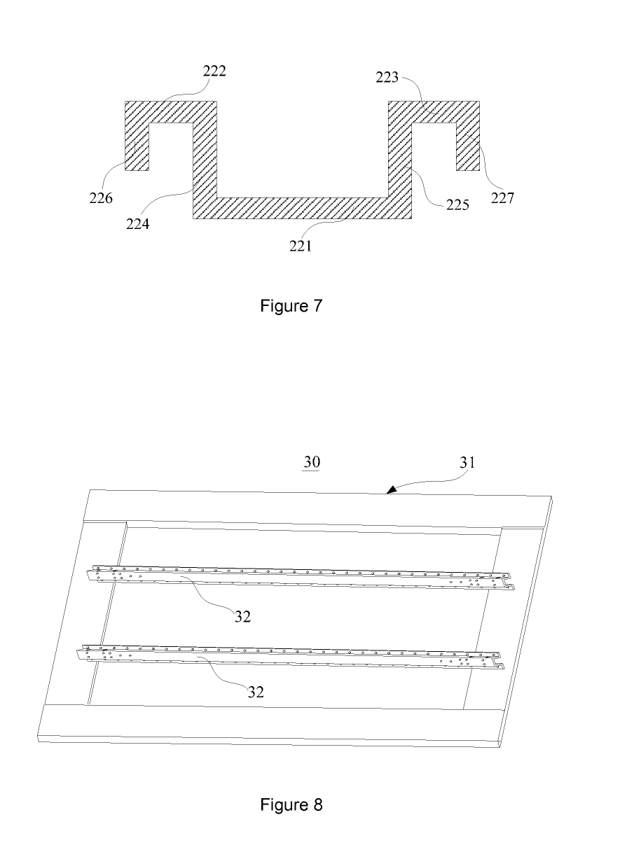

Referring to FIGS. 5-7, FIG. 5 is a schematic view showing the structure of the second embodiment of the backplane structure according to the present invention; FIG. 6 is a schematic view of the support beam shown in FIG. 5; and FIG. 7 is a cross-sectional view of the support beam shown in FIG. 5. The support beam 22 comprises a first horizontal wall 221, a second horizontal wall 222, a third horizontal wall 223, a first vertical wall 224, a second vertical wall 225, a third vertical wall 226 and a fourth vertical wall 227.

The first horizontal wall 221 is fixed to the backplane main body 21. The second horizontal wall 222 and the third horizontal wall 223 are disposed parallely to the backplane main body 21 with interval so that the second horizontal wall 222 and the third horizontal wall 223 are further away from the backplane main body 21 than the first horizontal wall 221.

The first vertical wall 221 and the second vertical wall 222 extend respectively from the two ends of the first horizontal wall towards away from the backplane main body. The second horizontal wall 222 extends from the end of the first vertical wall away from the first horizontal wall 221 along a first direction parallel to the first horizontal wall 221. The third horizontal wall 223 extends from the end of the second vertical wall 225 away from the first horizontal wall 221 along a second direction parallel to the first horizontal wall 221. The third vertical wall 226 extends from the end of the second horizontal wall 222 away from the first vertical wall 221 along a direction parallel to the first vertical wall 221 towards the first horizontal wall 221. The fourth vertical wall 227 extends from the end of the third horizontal wall 223 away from the second vertical wall 225 along a direction parallel to the second vertical wall 225 towards the first horizontal wall 221.

In the instant embodiment, the second direction is opposite to the first direction. The first vertical wall 224 and the second vertical wall 225 have a same height, and the third vertical wall 226 and the fourth vertical wall 227 have a same height. In the instant embodiment, the height of the first vertical wall 224 is higher than the height of the third vertical wall 226. It is obvious, in other embodiments, the height of the first vertical wall 224 is not restricted to be higher than the height of the third vertical wall 226. The specific height depends on the application.

Furthermore, the first horizontal wall is disposed with installation hole 228. A screw 23 passes the installation hole 228 to fasten the support beam 22 to the backplane main body 21. It is obvious that, in other embodiments, the support beam 22 can be soldered to the backplane main body 21 for fastening. The second horizontal wall 222 and the third horizontal wall 223 are disposed respectively with hanging hole 230. The hanging hole 230 can also include a rivet to apply the force to the support beam 22 so that the support beam 22 can support the entire backplane structure 20. The first vertical wall 224 and the second vertical wall 225 are disposed respectively with lifting hole 229. A steel string can pass the lifting hole 229 to hoist up the entire backplane structure 20. It is obvious the lifting hole 229 is not restricted to be disposed on the first vertical wall 224 and the second vertical wall 225. In other embodiments, the lifting hole 229 can also be disposed on the third vertical wall 226 and the fourth vertical wall 227.

It should be noted that the support beam can further comprises a fourth horizontal wall, a fifth horizontal wall, a fifth vertical wall and a sixth vertical wall. The specific condition depends on the actual application.

FIG. 8 is a schematic view showing the structure of the third embodiment of the backplane structure according to the present invention. As shown in FIG. 8, the backplane structure 30 comprises a backplane main body 31 and support beams 32. Compared to the embodiment shown in FIG. 1, the main difference is that the support beam 32 is fixed to the backplane main body 31 along the length direction of the backplane main body 31.

It should be noted that, in other embodiments, the support beam is not restricted to the disposition in FIG. 1 and FIG. 8. The support beam can also be disposed along the diagonal of the backplane main body. The specific condition depends on the actual application.

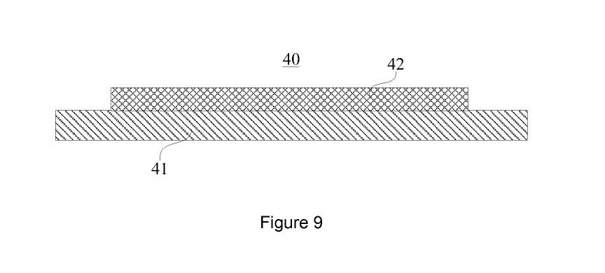

The present further provides a display device, shown in FIG. 9. FIG. 9 is a schematic modular view showing the display device according to the present invention. Display device 40 comprises a backplane 41 and a display module 42 disposed on the backplane 41, wherein the backplane 41 can be of any structure of the previous embodiments.

Compared to the known technique, the backplane structure and the display device thereof of the present invention can apply the force to the support beam to enhance the overall strength and rigidity of the entire backplane through disposing support beam on the backplane main body and the support beam, disposing perpendicularly connected horizontal wall and vertical wall on the support beam and disposing hanging hole on the horizontal wall that is disposed parallely to the backplane main body with interval. In addition, the horizontal wall and the vertical wall of the support beam can be formed through bending by knife bending machine to save the cost of expensive mold and reduce the manufacturing cost.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the claims of the present invention.

What is claimed is:

1. A backplane structure, which comprises:
a backplane main body; and
at least a support beam;
wherein the support beam comprising at least a horizontal wall and at least a vertical wall, the horizontal wall and the adjacent vertical wall being connected perpendicularly, at least a horizontal wall disposed parallely to the backplane main body with interval being disposed with a hanging hole;
the support beam being fixed to the backplane main body along the direction parallel to the length of the backplane main body;
wherein the support beam comprising a first horizontal wall, a second horizontal wall, a third horizontal wall, a first vertical wall and a second vertical wall;
wherein the first horizontal wall being disposed with hanging hole;
the first vertical wall and the second vertical wall extending respectively from the two ends of the first horizontal wall towards the backplane main body;
the second horizontal wall extending from the end of the first vertical wall away from the first horizontal wall along a first direction parallel to the first horizontal wall;
the third horizontal wall extending from the end of the second vertical wall away from the first horizontal wall along a second direction parallel to the first horizontal wall; the second direction being opposite to the first direction;
wherein the first vertical wall and the second vertical wall having a same height, the second horizontal wall and the third horizontal wall being fixed to the backplane main body; the first horizontal wall being further away from the backplane main body than the second horizontal wall and the third horizontal wall.

2. The backplane structure as claimed in claim 1, characterized in that the support beam has a thickness of 1-4 mm.

3. A backplane structure, which comprises:
a backplane main body;
at least a support beam; the support beam being fixed to the backplane main body;
wherein the support beam comprising at least a horizontal wall and at least a vertical wall, the horizontal wall and the adjacent vertical wall being connected perpendicularly, at least a horizontal wall disposed parallely to the backplane main body with interval being disposed with a hanging hole.

4. The backplane structure as claimed in claim 3, characterized in that the support beam is fixed to the backplane main body along the direction parallel to the length of the backplane main body.

5. The backplane structure as claimed in claim 3, characterized in that the support beam is fixed to the backplane main body along the direction parallel to the width of the backplane main body.

6. The backplane structure as claimed in claim 3, characterized in that the support beam comprises a first horizontal wall, a second horizontal wall, a third horizontal wall, a first vertical wall and a second vertical wall; wherein
the first horizontal wall being disposed with hanging hole;
the first vertical wall and the second vertical wall extending respectively from the two ends of the first horizontal wall towards the backplane main body;
the second horizontal wall extending from the end of the first vertical wall away from the first horizontal wall along a first direction parallel to the first horizontal wall;
the third horizontal wall extending from the end of the second vertical wall away from the first horizontal wall along a second direction parallel to the first horizontal wall; the second direction being opposite to the first direction;
wherein the first vertical wall and the second vertical wall having a same height, the second horizontal wall and the third horizontal wall being fixed to the backplane main body; the first horizontal wall being further away from the backplane main body than the second horizontal wall and the third horizontal wall.

7. The backplane structure as claimed in claim 6, characterized in that the first vertical wall and the second vertical wall are disposed respectively with lifting hole.

8. The backplane structure as claimed in claim 7, characterized in that the second horizontal wall and the third horizontal wall are disposed respectively with installation hole.

9. The backplane structure as claimed in claim 3, characterized in that the support beam comprises a first horizontal wall, a second horizontal wall, a third horizontal wall, a first vertical wall, a second vertical wall, a third vertical wall and a fourth vertical wall; wherein
the first vertical wall and the second vertical wall extending respectively from the two ends of the first horizontal wall towards away from the backplane main body;
the second horizontal wall extending from the end of the first vertical wall away from the first horizontal wall along a first direction parallel to the first horizontal wall;
the third horizontal wall extending from the end of the second vertical wall away from the first horizontal wall along a second direction parallel to the first horizontal wall; the second direction being opposite to the first direction;
the third vertical wall extending from the end of the second horizontal wall away from the first vertical wall along a direction parallel to the first vertical wall towards the first horizontal wall;
the fourth vertical wall extending from the end of the third horizontal wall away from the second vertical wall along a direction parallel to the second vertical wall towards the first horizontal wall;
wherein the first vertical wall and the second vertical wall having a same height; the first horizontal wall being fixed to the backplane main body; the second horizontal wall and the third horizontal wall being further away from the backplane main body than the first horizontal wall; the second horizontal wall and the third horizontal wall being disposed respectively with hanging hole.

10. The backplane structure as claimed in claim 9, characterized in that the first horizontal wall is disposed with installation hole.

11. The backplane structure as claimed in claim 10, characterized in that the first vertical wall and the second vertical wall are disposed respectively with lifting hole.

12. A display device, which comprises a backplane structure, the backplane structure comprising:
a backplane main body;
at least a support beam; the support beam being fixed to the backplane main body;
wherein the support beam comprising at least a horizontal wall and at least a vertical wall, the horizontal wall and the adjacent vertical wall being connected perpendicularly, at least a horizontal wall disposed parallely to the backplane main body with interval being disposed with a hanging hole.

13. The backplane structure as claimed in claim 12, characterized in that the support beam is fixed to the backplane main body along the direction parallel to the length of the backplane main body.

14. The backplane structure as claimed in claim 12, characterized in that the support beam is fixed to the backplane main body along the direction parallel to the width of the backplane main body.

15. The backplane structure as claimed in claim 12, characterized in that the support beam comprises a first horizontal wall, a second horizontal wall, a third horizontal wall, a first vertical wall and a second vertical wall; wherein
the first horizontal wall being disposed with hanging hole;
the first vertical wall and the second vertical wall extending respectively from the two ends of the first horizontal wall towards the backplane main body;
the second horizontal wall extending from the end of the first vertical wall away from the first horizontal wall along a first direction parallel to the first horizontal wall;
the third horizontal wall extending from the end of the second vertical wall away from the first horizontal wall along a second direction parallel to the first horizontal wall; the second direction being opposite to the first direction;
wherein the first vertical wall and the second vertical wall having a same height, the second horizontal wall and the third horizontal wall being fixed to the backplane main body; the first horizontal wall being further away from the backplane main body than the second horizontal wall and the third horizontal wall.

16. The backplane structure as claimed in claim 15, characterized in that the first vertical wall and the second vertical wall are disposed respectively with lifting hole.

17. The backplane structure as claimed in claim 16, characterized in that the second horizontal wall and the third horizontal wall are disposed respectively with installation hole.

18. The backplane structure as claimed in claim 12, characterized in that the support beam comprises a first horizontal wall, a second horizontal wall, a third horizontal wall, a first vertical wall, a second vertical wall, a third vertical wall and a fourth vertical wall; wherein
the first vertical wall and the second vertical wall extending respectively from the two ends of the first horizontal wall towards away from the backplane main body;
the second horizontal wall extending from the end of the first vertical wall away from the first horizontal wall along a first direction parallel to the first horizontal wall;
the third horizontal wall extending from the end of the second vertical wall away from the first horizontal wall along a second direction parallel to the first horizontal wall; the second direction being opposite to the first direction;
the third vertical wall extending from the end of the second horizontal wall away from the first vertical wall along a direction parallel to the first vertical wall towards the first horizontal wall;
the fourth vertical wall extending from the end of the third horizontal wall away from the second vertical wall along a direction parallel to the second vertical wall towards the first horizontal wall;
wherein the first vertical wall and the second vertical wall having a same height; the first horizontal wall being fixed to the backplane main body; the second horizontal wall and the third horizontal wall being further away from the backplane main body than the first horizontal wall; the second horizontal wall and the third horizontal wall being disposed respectively with hanging hole.

19. The backplane structure as claimed in claim 18, characterized in that the first horizontal wall is disposed with installation hole.

20. The backplane structure as claimed in claim 19, characterized in that the first vertical wall and the second vertical wall are disposed respectively with lifting hole.
